(19) United States
(12) Patent Application Publication
(10) Pub. No.: US 2001/0033284 A1
(43) Pub. Date: Oct. 25, 2001

(54) Method and system for dynamic graphical information transfer on a web page

(76) Inventor: Timothy Chan, New York, NY (US)

Correspondence Address: Timothy Chan, 200 Rector Place # 23H, New York, NY, 10280-1168, US

(21) Appl. No.: 09/793,207

(22) Filed: Feb. 26, 2001

Related U.S. Application Data
(60) Provisional application No. 60/188,985, filed on Mar. 13, 2000.

(51) Int. Cl. G06T 11/20

(52) U.S. Cl. 345/441; 345/581; 345/629

(57) ABSTRACT

A method and system for conveyance over a network of dynamic information about multiple entities to be displayed graphically on a map to an end user. Wherein the map contains a collection of graphical representations of real tangible entities with a relatively fixed location to one another. The dynamic information about the entities will be transferred separately from the static portions, hence avoiding the inefficiencies of transferring the data as a finished file to the end user.

### CROSS-REFERENCE TO RELATED APPLICATIONS

The present application is based on the Applicant's U.S. Provisional patent application Ser. No. 60/188,985, entitled “Method and system for dynamic graphical information transfer on a web page” filed on Mar. 13, 2000.

### STATEMENT REGARDING FEDERALLY SPONSORED RESEARCH OR DEVELOPMENT

Not applicable

### REFERENCE TO A MICROFICHE APPENDIX

Not applicable

### BACKGROUND OF INVENTION

1. Field of Invention

The invention relates to the transfer of image or graphical information over a network, specifically to the transfer of dynamic image data.

Computer networks have revolutionized the access and speed with which individuals can retrieve information, such as with the Internet. In many instances the information is time sensitive hence dynamic, and must be updated nearly continuously. Currently all ‘real-time’ dynamic data available over networks such as the Internet must be retrieved in text form, due to server hardware and software being optimized for text and numeric processes. Unfortunately text isn't the best method of presentation for all purposes. In many situations a graphical representation would serve this purpose much better. One example is that of a map, which shall be defined as a collection of graphical representations of real tangible entities with a relatively fixed location to one another. Some examples are: a map of the United States, which is a collection of states, regions, and roads; a bus map, which is a collection of bus routes, streets, and city blocks; a theater map a collection of seats, aisle, and entrances; and others not to be limited by these examples. With a map one can symbolize the state of certain dynamic attributes of multiple individual entities through the use of colored lines, shapes, and icons placed on the map. One caveat of a map is that the dynamic attributes of each underlying entity can and are usually independent of each other. Hence to represent the dynamic attributes of a collection of entities in a map format requires creating numerous graphical files, due to the infinite combination that can occur, such as just a simple weather map displaying regional temperatures around the United States. Therefore dynamic image maps cannot be fully pre-generated and stored for retrieval later.

2. Description of Prior Art

It is possible currently to make dynamic information available in a graphical form such as displaying traffic conditions on a road map. However the generation of these ‘real-time’ maps can exact a heavy burden on a server and network. For each instance when a change occurs a server needs to generate a new graphics file (denoted by 105 in FIG. 1) stored on the server, which when requested is then to be transferred as a static image file over a network 999 to an end user using a computer device with a output display, input apparatuses and browser software, henceforth referred to as the client. The procedure in (FIG. 1) of generating each graphics file 105 instance requires first loading (process denoted 101) a base image file (denoted 002) to which the dynamic data (denoted 001) is to be added, and requires the manipulation of the entire base image 002. The dynamic data 001 must be interpreted (process denoted 100) for rendering and incorporated (process denoted 102) into the base image 002. The interpretation process 100 involves converting the dynamic data 001 into graphical representations to be plotted on the map, and the incorporation process 102 renders the representations on the base image 002. Afterwards the modified image is recompressed (process denoted 103) and saved (process denoted 104) as a static image file (denoted 105) on the server. All the pointers to the semi-dynamic image must then be updated to point to the current instance of the static image file 105. Also the dynamic text and/or numeric processes as denote in FIG. 1 by 000 must be run before the graphics processes can be executed, since those text/numeric results are inputs for the graphics processes.

Given that change in most phenomenons is continuous and independent i.e. traffic conditions around a city, weather from region to region, and other time related phenomenons, it thus requires generation and maintenance of countless image files 105 to accurately represent a physical phenomenon through a network to an end user. This would overwhelm and stall most servers and perhaps even causing a crash, since most servers are design to retrieve files or run databases in a multi-user environment and are not optimized to run graphics routines, which take up more processing time and storage space than text and numeric data processes. In a decompressed GIF image each pixel is 1 byte, and in a decompressed JPEG image each pixel can be as much as 3 bytes, compare to an ASCII text character of 1 byte. Contrast this with the amount of pixels need to graphically communicate a single ASCII character or any other information, demonstrates why graphics operations on a server can causes an enormous performance burden relative to manipulating the same information in text/numeric form, making it much cheaper to convey dynamic information as text data. Therefore it is inefficient and very difficult with current server technology to use a graphical data format for dynamic information, and achieve the accuracy and performance possible with ‘real-time’ dynamic text/numeric information.

One alternative currently being used on the World Wide Web is to provided ‘semi real-time’ information, so the graphical representation file 105 needs to be updated less often at the cost of providing less accurate and precise information to a user. However even at an update interval of 5 minutes this can still be a burden to the server, given that a normal compressed detailed graphic file is well over 200 kilobytes. Hence still consuming considerable useful resources in saving and processing multiple instances of compressed image data each hour. The amount of actual raw data processed to generating each instance of the graphical files for download can be more than double the finished file size, since the individual pixels of an uncompressed base image must be modified to incorporate the dynamic information and then be recompressed for network access.

To further improve the performance of the above approach, one possible solution is to add more hardware specifically for processing the graphical files, hence increasing cost. However this is still inefficient wasting valuable resources, considering that after the server expends useful capacity and processing cycles to generate the dynamic information graphically (file 105) it is discarded after the update interval, since it is out of date with no further possible use, unlike the generation of dynamic data in text/numeric form that can be use for other purposes, such as statistical analysis of the data by the client. One additional drawback with this method is that each individual time instance of the graphical data file 105 can contain over 70% redundant static information from the base image 002, which is negatively related to the number of entities and entity size on the map that must be processed and incorporated. Hence most of the processing resources and time expended above by the server involve manipulation, recompression, and transfer of a lot of redundant image information with a very short usable lifespan. A need has therefore been recognized for a method, which makes possible transfer of ‘real-time’ dynamic information of multiple entities graphically and also avoids the inefficiencies above.

### BRIEF SUMMARY OF THE INVENTION

Currently all ‘semi real-time’ dynamic graphical information transferred over networks using HTTP (Hyper Text Transfer Protocol) can only be sent as static image files with all the dynamic information already incorporated into the file. The present invention seeks to make possible the transfer of ‘real-time’ dynamic information of multiple entities graphically, while avoiding the prior method's shortcomings.

The present invention introduces a new method to transfer data graphically, involving a program object to be transferred and run on a client, which allows for explicit separation of the static base image containing a collection of graphical representations of entities from its related dynamic entity information. The executable object takes a static base image map file and related dynamic entity information and compiles the two on the client to make possible a true ‘real-time’ dynamic map while reducing the burden on the server. This method allows for easy and immediate modification of the status of any entity attribute represented on the map by, using regular text and numeric processes on the server. Hence with this method there is not the need to directly modify the pixels of the base image, which would be much more time and resource consuming, than the simple text and numeric processes. Since the server manipulates the dynamic data in text and numeric form and not the graphics files, it saves the resources on the server that were previously allocated to process, recompress, and save each instance of the updated graphical data file 105. Furthermore there is not the need to save or recompress the graphics file in the client either, since the base image does not need to be actually altered by the client, which greatly reduces the resources in total spent in the processing and compression of mostly redundant data. The executable object that is downloaded and run on the client will display the base image map just as any image file is displayed on the client and render the dynamic information on top of the image map.

Besides the benefits described above, several objects and advantages of the present invention are specifically:

The ability to represent multiple independent dynamic attributes of multiple entities over a network to an end user graphically in an efficient manner, allowing for new uses of maps in conveying dynamic information.

The ability to transfer true ‘real-time’ graphical information of multiple entities up to the extent already possible with text data, by explicit separation of the dynamic entity information from the static base image for transfer.

Reduce server load by eliminating processes in FIG. 1 denoted by 100, 101, 102, 103 and 104 from the server.

Reduce the amount of redundant data that is processed on the server, since there is not any loading, modification, recompressing, or saving of a sizable base graphics image denoted by 002 in FIG. 1.

Greatly reduce amount of resources spent in generating instances of sizable image files with limited useful life span by eliminating image file 105 in FIG. 1

Eliminates the wasted resources expended in total to generate, recompress, and save each individual time instance of the dynamic information graphically. In FIG. 1 eliminates completely the processes denoted by 101, 103, and 104 from both server and client.

Allows more efficient transfer of dynamic information graphically than currently available when used in conjunction with a cache-enabled browser, since the larger static portions are automatically cached for later access, requiring transfer of only the smaller dynamic portion. Hence reducing bandwidth consumed and reducing access time of the ‘real-time’ dynamic graphical information. Furthermore with the prior art method each instance of the updated graphic file 105 maybe cached by the client, which can quickly clutter the cache if the ‘semi real-time’ dynamic graphical information is accessed frequently.

Further objects and advantage of my invention will become apparent from a consideration of the diagrams and ensuing description.

### BRIEF DESCRIPTION OF THE SEVERAL VIEWS OF THE DRAWING

In FIG. 1 and FIG. 2 the rectangles with rounded corners represents processes and the smaller sized rectangles represents data storage to which information is written or read. The left side of the page shows the processes executed on the server in order to make available for transfer over a network the dynamic information in graphical form. The right side column shows the processes to be executed on the client to display the graphical information, after the web page is transferred and loaded on the client.

FIG. 1 represents the processes involved in implementing the prior art method.

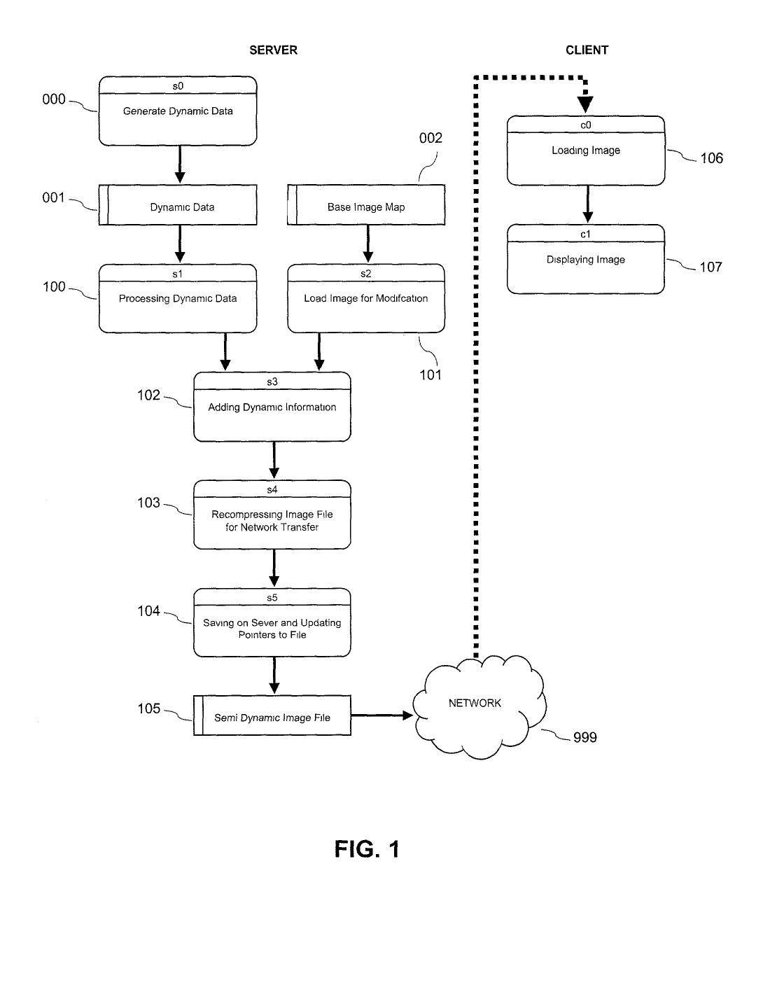

FIG. 2 represents the processes involved in implementing the present invention.

FIG. 3 shows the data components in the present invention graphically and the compilation of the distinct data components graphically rendered.

FIG. 4 shows a scaled version of the rendered end results presented to the end user in 3205 with a legend also rendered.

FIG. 5 depicts a base map where each entity is a distinct shape-object stored together as a vector image to form the base map.

### DETAILED DESCRIPTION OF THE INVENTION

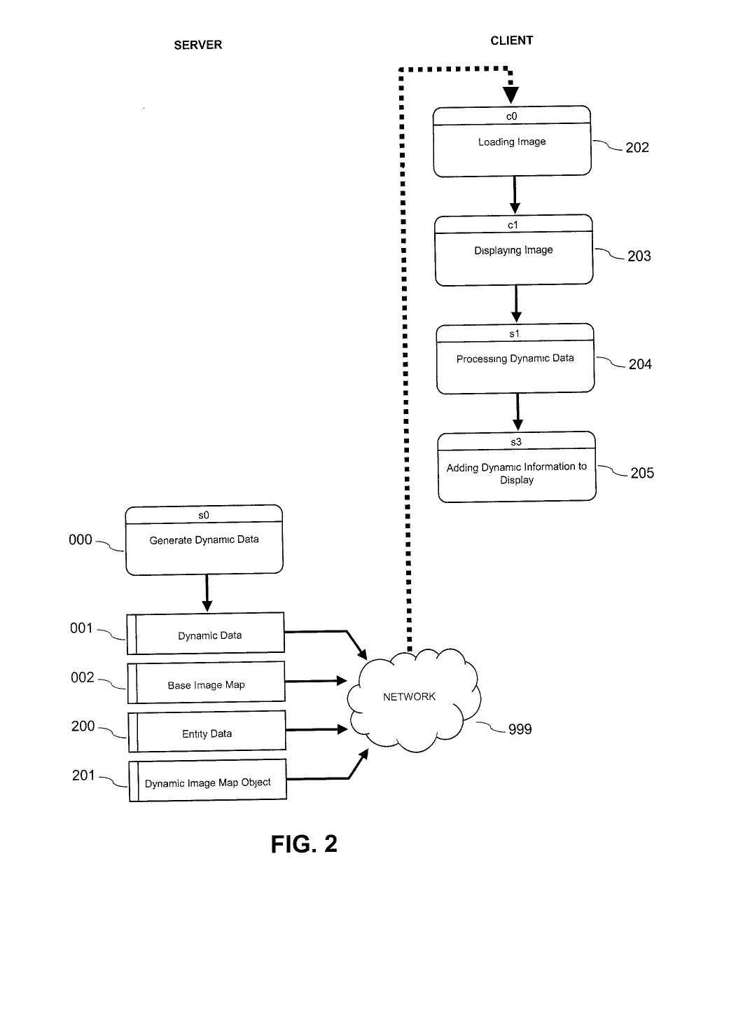

The present invention introduces a new method as shown in FIG. 2 to transfer dynamic information in a graphical form such as the map described above in the BACKGROUND section. The method involves the transfer of 4 distinct portions of data: a separate ‘real-time’ dynamic data component (denoted by 001), related entity data (denoted by 200), a static base image (denoted by 002), and an executable object component (denoted by 201). After the distinct components of data are transferred over a network to the client, the executable dynamic-image-map object component 201 will load (process denoted 202) and display (process denoted 203) the static base image 002 and, then interpret (process denoted 204) and render (process denoted 205) the dynamic data 001 using its related entity data 200 on the static base image 002.

The static base image 002 can be of any image format, such as a raster type, i.e. a GIF, a JPEG, a PNG or a vector type, i.e. a WMF, a SVG or any graphical format. The static base image 002 is to be utilized as a background on which the dynamic entity information is rendered.

The ‘real-time’ dynamic data 001 and entity data 200 both can be in an alphanumeric text format, hence readable by humans, but the preferred format would be binary so as to minimize the file size and the conversion of numbers to text and back. Also both data pieces can be retrieved from an actual file on a server, a JSP, a CGI script, the query results from a database, or any resource.

The entity data 200 will indicate the different possible appearances or styles of representation for each entity's different attribute statuses in the dynamic data 001. Specifically each entity's attribute status can have two or more states, which could be indicated on a base image 002, by simply setting it to non-visible or visible, or by representation through the use of lines, shapes, and small icon images. The lines and shapes can be distinguished further with the weight of the lines, segmentation (dashed lines), colors and/or intensities. The shapes can also be an outline or a filled shape with solid fills, patterned fills, gradient fills, etc. An icon image would require transfer of an extra image file, which also can be animated. Hence it is possible to represent more than one dynamic attribute for each entity graphically and/or different entity types on the base image 002. It is also possible to render regular text characters on the base image 002 if needed.

The entity data 200 will also contain the positional and boundary data for each entity in dynamic data 001 that is to be used for placing the entities' representation on the base image 002. Hence the entity data 200 will indicate what appearance the different statuses each individual entity will have graphically and where each individual entity is positioned and its bounds on the base image 002. Each entity's positional data (contained in entity data 200) for its graphical depiction on the base image 002 will be humanly generated or computer generated, as when technology reaches the stage where artificial intelligence can execute such cognitive processes. The quantity of positional data (coordinate points) required for each entity would depend on its physical size on the map and form of representation. A straight line would only need the position of its two endpoints, whereas a line with multiple curves and/or bents would require the positions of its vertices similar to polygon or curve shape. An icon image representation or text would require the position of a single point such as the top left corner and the scale for the icon or the font for the text.

The ‘real-time’ dynamic data 001 will indicate for each entity on the base image 002 the entity's current attributes statuses, which will affect the appearance of the entity's graphical representations on the base image 002. Accordingly it must use some method of indication to match up with its corresponding entity in entity data 200. One method is ordering both the dynamic data 001 and entity data 200 in the same sequence, which would require that every entity's data be sent every time. The preferred implementation would be to assign each entity a unique index, so that the attributes statuses in dynamic data 001 can use the index for matching with its corresponding entity in entity data 200, without having to send each and every entity's statuses. Hence allowing for greater efficiency when the dynamic data 001 is continuously streamed or sent as a completed file to the client. An entity can also be subdivided, since it is possible for an entity to have different statuses for a single attribute. For example a street can be congested on one block and several blocks away have very little traffic. Hence an entity can be assigned more than one index to subdivide its representation on the map, to allow for more precise information to be conveyed on the client. This would also increase the amount of coordinate data required i.e. a line with two endpoints divided into 2, would have 2 endpoints for each of the resulting 2 segments.

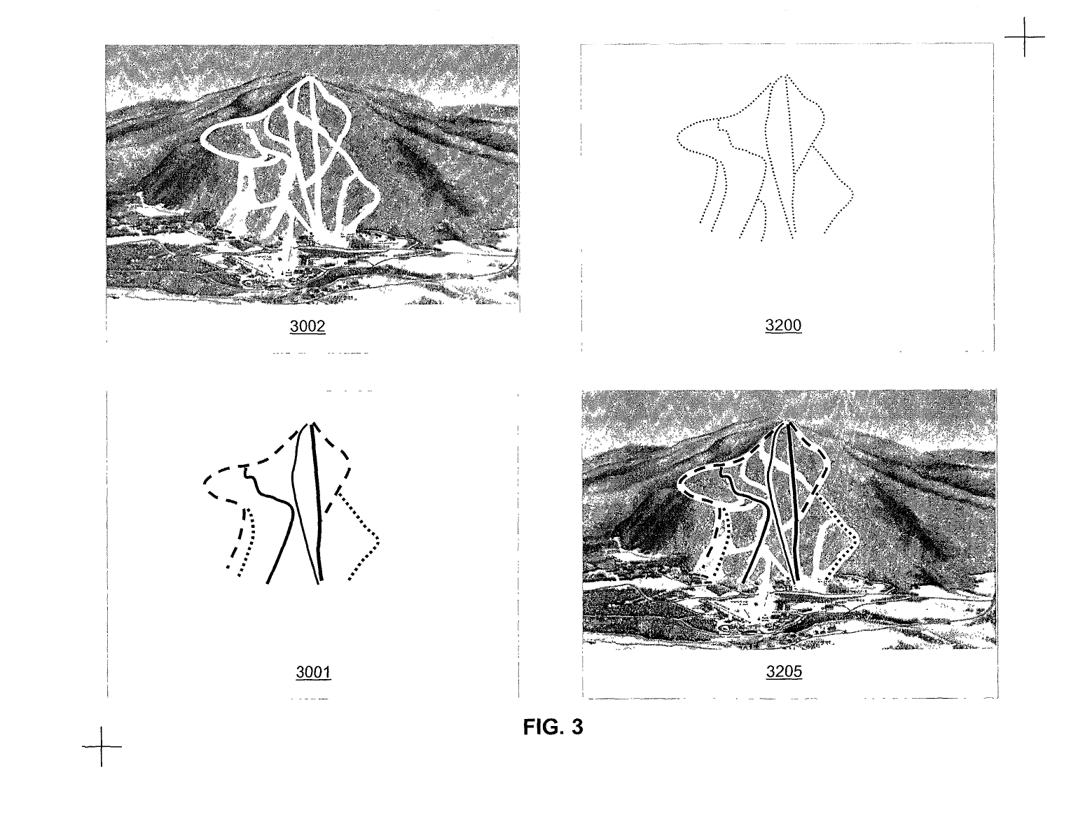

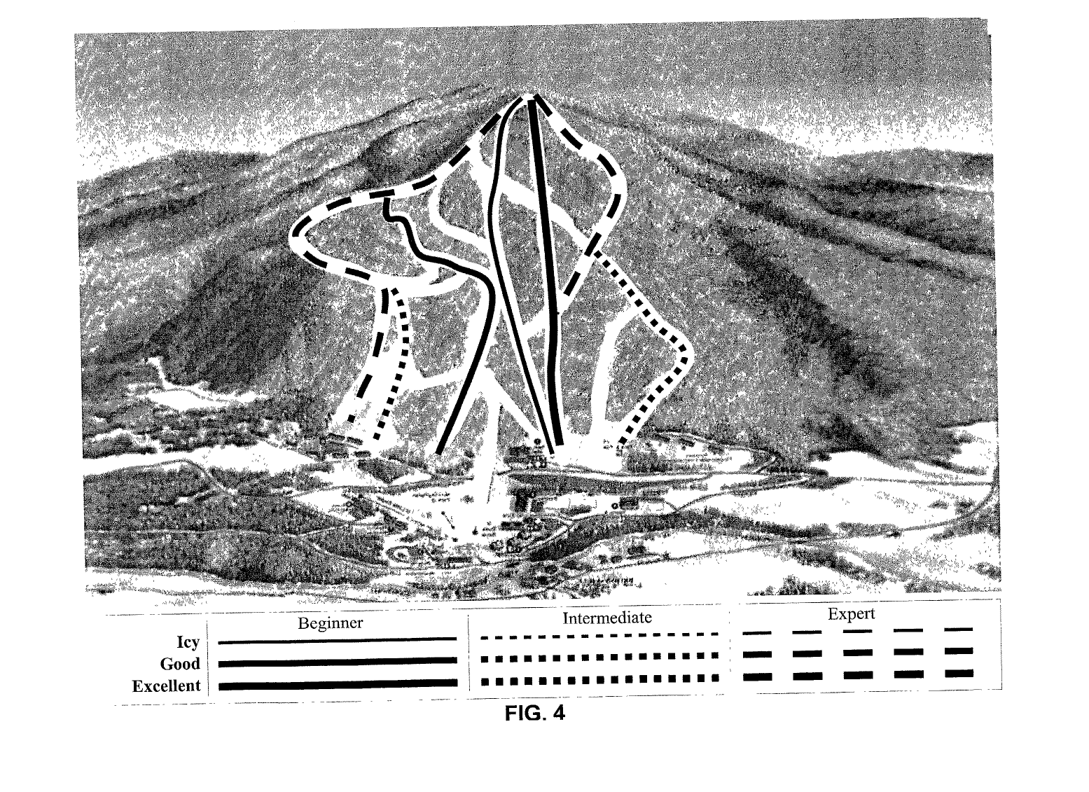

An example, which will be used to help better illustrate how the data components all fits together, is a dynamic ski trail map, that a skier can use to check current ski trail conditions. The base image 002 in this example is shown by the trail map 3002 in FIG. 3, each ski trail on the map is an entity, and its position and bounds will be specified in the entity data 200 and a collection of trail entities is plotted in 3200 of FIG. 3 to help depict the data semantically. To elaborate entity data 200 will contain for each trail entity the positional and boundary data of the lines plotted to the run of each trail. Each ski trail entity can have many attributes, two of which will be represented on the map for the present purpose. The first attribute, which will be represented, is the degree of difficultly of the trail, the possible attribute values being beginners, intermediate, and expert. The second attribute to be represented will be the trail conditions, the possible statuses being closed, icy, good, and excellent, for simplicity. The line dashing will be used to represent the degree of difficulty i.e. solid line for beginner; short dashes for intermediate; long dashes for expert, while the trail conditions attribute in the example can be represented by the weight of the line, not visible for closed; a thin line for icy, a thicker line for good; and the thickest line for excellent. The dynamic data 001 in the example will indicate the status for the two above attributes for each entity on the map and when combine with entity data 200 will show the entities formatted with their current conditions as rendered in 3001 of FIG. 3. When this is rendered on top of the base map 3002 we get the finished result 3205 of FIG. 3, displayed to the end user by the executable object 201. FIG. 4 shows a normal scaled version of 3205 with a legend added—visually the finished results would be much neater and clear when utilizing color as intend by the present invention i.e., instead of dashing to distinguish the level of difficulty, use color to represent the degree of difficulty such as green for beginner; blue for intermediate; black for expert. The entity data 200 can also be render twice on the base image 002, the first rendering would be in a base color (white in this case) with slightly larger boundary dimensions, so as to provided a better contrasting background for the composite entity data 200 and dynamic data 001 to be rendered on top of. Hence making the entities more readily distinguishable from the surrounding graphics.

The executable dynamic-image-map object denoted by 201 in FIG. 2 will load (process 202) the base image 002, and display (process 203) the base image 002 on the client (as seen in 3002), with the exception that the executable dynamic-image-map object 201 handles the execution instead of the browser software. The executable dynamic-image-map object 201 next interprets (process 204) the dynamic data 001 and entity data 200 (as shown in 3001) and adds the dynamic data graphically (process 205) on top of the base image 002 (both process that were previously done by the server) leading to the results as seen in 3205. The preferred implementation of the executable dynamic-image-map object 201 would be a JAVA applet, since it does not require direct installation by the user to execute and should not be noticeable to the user, working just like a regular web page. It is also possible to implement the object through a software plug-ins to the browser written in a different programming language, which would need installation. The dynamic-image-map object 201 will utilize a single initialization file for locating each of the required data components, so as to minimize the chances of errors, if they where pointed to in the base document containing the executable object file 201. Hence the HTML document or any other SGML document containing the executable object file 201 will point to a single resource, which will in turn point to the other required components' ‘file’ location on the server. Entity data 200 can be used for this purpose of centralizing this ‘file’ location information.

An addition feature is to group entities according to a particular attribute of the entities to allow the user choose which groups are to be displayed. With the above ski trail map example the trail entities can be grouped by the difficulty attribute, which would allow a skier to select to view only the trails suited to the skier's skills and preferences.

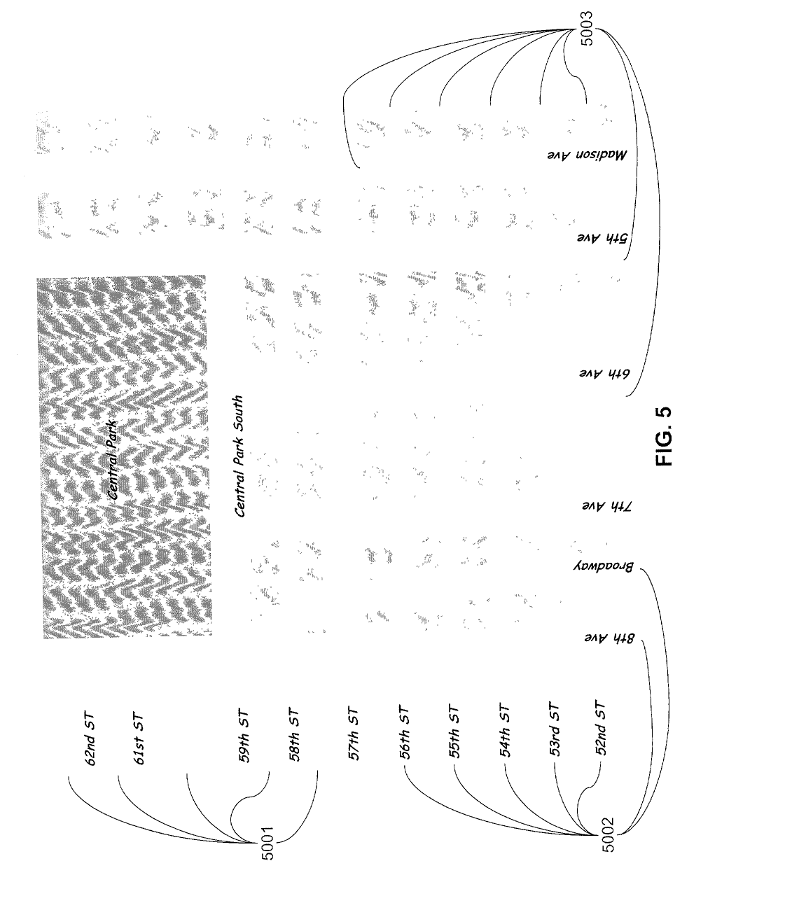

In the preferred embodiment the base image 002 will be in a vector format where each entity is a vector shape-object within the image that can be manipulated to reflect the current statuses of each entity's attributes. In essences this would mean that the base image 002 encompasses the entity data 200, or to put it another way the entity data 200 is used to render the bulk of the base image 002. Since the entity data 200 already contains the positional and boundary data that is used to render each entity, which may contain substantially enough data be used to render the entire map. To help demonstrate this, FIG. 5 contains an illustration of a vector image where all the entities in the image are constructed of vector shape-objects and the entire map constructed of these entities. There are multiple city-block entities (all the gray shapes) a few of which are being denoted 5001; there are multiple text label entities (all the black italic text) several of which are being denoted 5002; and there are multiple street entities (all the white pathways between the city-block entities) a few of which are being denoted 5003. These street entities do intersect but the overlaps are not visually illustrated on the map. Each of the entities are stored as a vector shape-object in the base image 002 file, and can be manipulated to reflect the current attribute statuses of the underlying entities, using color or any of the before mentioned methods. The street entities can be further subdivided and given a unique index to provide more precise manipulations and their representations can overlap if needed. If the map does contains areas where there aren't entities and would look awkward such as with the mountain side in the ski map example it is possible to use a smaller raster image to cover up those areas.

An additional embodiment for dealing with very large and detailed base image 002, it is possible to transfer the large static portion by other means, such as on a disk and run the executable object file 201 as a regular application outside the browser, utilizing the same network connection as the browser did.

With alternate methods that do not use the base image 002 format as specified in the preferred embodiment and illustrated in FIG. 5. It is also possible to use an additional static base image that is a transparent mask, which contains the graphical data that must not be cover by the rendering of the dynamic entity information. This can be achieved by rendering the static transparent mask image last, so that it becomes the top most layer of the object. However this extra static transparent mask image does require transfer of an extra data file. This static transparent mask image can also be use in place of the static base image 002 that serves as the background. To accomplish this the dynamic entity data is rendered graphically first and then the transparent mask image is rendered after it for display to the user.

As explained in detail above, the invention allows for the transfer of ‘real-time’ dynamic information of multiple entities and attributes to be presented to the end user in a graphical map form. The invention reduces the burden on a server and does not increase the burden on the client by an equal amount, hence reducing resources in total expended in processing the dynamic information. Furthermore it reduces the amount of resources wasted by the prior art that was used to process redundant information.

While the invention has been illustrated and described in the preferred embodiments, many modifications and changes therein may be affected by those skilled in the art. It is to be understood that the invention is not limited to the precise construction herein disclosed. For example the use of a different network protocol. Accordingly, it will be appreciated by those skilled in the art, that variations may be made thereto without departing from the spirit of the invention or the scope of the appended claims.

What is claimed is:

1. An information processing system comprising:
(a) a static-data portion, which maybe cache on a client computer device with a display and a input apparatus
(b) a dynamic-data portion, which is retrieved from a server through a network
(c) said static-data comprising of an executable program object, a base map graphics file, and a data portion indicating a location and a depiction of at least a single entity on said base map graphics file
(d) said base map graphics file containing a collection of graphical representations of real tangible entities
(e) said dynamic-data indicating at least a single attribute status of at least one said entity present on said base map graphics file
(f) said executable program object will display said base map graphics file on said client machine as a map image, and render at least one said entity on said map image
(g) said location and said depiction will be used to plot said entity's shape on a section of said map image
(h) said entity will be rendered on said map image utilizing said entity's said location and said depiction in conjunction with the said entity's said attribute status
(i) said attribute status can be shown graphically through the use of at least one method selected from group consisting of different colors, patterned fills, dashes, and weight of lines used in said depiction
whereby enabling the transfer of multiple independent attributes of multiple entities for display graphically to an end-user over a network,
whereby reducing the total network bandwidth required to retrieve multiple discrete dynamic information graphically,
whereby reducing the server load required to make available multiple discrete dynamic information graphically.

2. The information processing system of claim 1 wherein the said dynamic-data is transfer as a completed file to said client machine.

3. The information processing system of claim 1 wherein the said dynamic-data is transfer as a continuous data stream to said client machine,
whereby enabling said image map to show real time dynamic data graphically without consuming considerable network system resources,
whereby automatically displaying new data to the client as the data becomes available.

4. The information processing system of claim 1 further comprising of the ability to filter display of said entities according to the said entities' attributes,
whereby enabling the user to display certain entities' information and hide others.

5. The static portion of claim 1 wherein said executable program object is a java applet to be run in a web browser.

6. The static portion of claim 1 wherein the said base map graphics file is in a vector format and said location and said depiction data of said entity is stored as a vector shape-object contained in the vector base map graphics file
(a) the vector base map will contain at least one said vector shape-object to represent each said entity
(b) said vector shape-object in the vector base map will be addressable so that each said vector shape-object can be manipulated graphically according to said entity's said attribute status
whereby making said base map graphics file scalable without deterioration in the render results displayed to the end-user,
whereby compiling said entities' said location and said depiction into said base map graphics file reducing the number of file sent and the total data sent.

7. A method for transfer of dynamic data over network to be displayed graphically comprising:
(a) a server connected to a network
(b) a client with ability to retrieve data from said sever over said network
(c) a static-data portion, which maybe cache on said client
(d) a dynamic-data portion to be retrieved from server
(e) said static-data comprising of an executable program object, a base map containing a collection of graphical representations of entities, and an entity data component containing information about said graphical representations of entities present on said base map
(f) said dynamic-data portion indicating dynamic information related to said graphical representations of entities
(g) a means by which the said static-data portion and said dynamic-data portion are complied on said client to create a visual map with the entities' dynamic information render on the map
whereby enabling the transfer of multiple independent attributes of multiple entities for display graphically to an end-user over a network,
whereby reducing the total network bandwidth required to retrieve multiple discrete dynamic information graphically,
whereby reducing the server load required to make available multiple discrete dynamic information graphically.

8. The method of claim 7 wherein the said dynamic-data is transfer as a completed file to said client machine.

9. The method of claim 7 wherein the said dynamic-data is transfer as a continuous data stream to said client machine,
whereby enabling said image map to show real time dynamic data graphically without consuming considerable network system resources,
whereby automatically displaying new data to the client as the data becomes available.

10. A communication system comprising:
(a) an instance of data to be displayed to an end user graphically over a network
(b) said instance of data containing dynamic-information about at least a single entity, which is retrieved from a server through said network and
(c) said instance of data having a related static-data portion, which also needs to be retrieved and maybe cache on a client computer device with a display and a input apparatus
(d) said static-data comprising of an executable program object, a base map graphics file, and a data portion indicating a location and a depiction of at least a single entity on said base map graphics file
(e) said base map graphics file containing a collection of graphical representations of real tangible entities with a relatively fixed location to one another
(f) said instance of data indicating at least a single attribute status of at least one said entity present on said base map graphics file
(g) said executable program object will display said base map graphics file on said client machine as a map image, and render at least one said entity on said map image
(h) said location and said depiction will be used to plot said entity's shape on a section of said map image
(i) said entity will be rendered on said map image utilizing said entity's said location and said depiction in conjunction with the said entity's said attribute status
(j) said attribute status can be shown graphically through the use of at least one method selected from group consisting of different colors, patterned fills, dashes, and weight of lines used in said depiction
whereby enabling the transfer of multiple independent attributes of multiple entities for display graphically to an end-user over a network,
whereby reducing the total network bandwidth required to retrieve multiple discrete dynamic information graphically,
whereby reducing the server load required to make available multiple discrete dynamic information graphically.

11. The information processing system of claim 10 wherein a single said instance of data is transfer as a completed file to said client machine.

12. The information processing system of claim 10 wherein multiple said instance of data is transfer as a continuous data stream to said client machine,
whereby enabling said image map to show real time dynamic data graphically without consuming considerable network system resources,
whereby automatically displaying new data to the client as the data becomes available.

13. The information processing system of claim 10 further comprising of the ability to filter display of said entities according to the said entities' attributes,
whereby enabling the user to display certain entities' information and hide others.
